(19) United States
(12) Patent Application Publication
(10) Pub. No.: US 2017/0337591 A1
(43) Pub. Date: Nov. 23, 2017

(54) AWARE SIGN

(71) Applicant: Adeel Ali, Raleigh, NC (US)

(72) Inventor: Adeel Ali, Raleigh, NC (US)

(21) Appl. No.: 15/471,940

(22) Filed: Mar. 28, 2017

Related U.S. Application Data
(60) Provisional application No. 62/339,738, filed on May 20, 2016.

(51) Int. Cl. G06Q 30/02

(52) U.S. Cl. CPC G06Q 30/0281; G06Q 30/0269

(57) ABSTRACT

Methods and systems for an aware sign are provided. According to one aspect, an aware sign comprises a visual display unit for displaying information to customers at a store, a processor, and a memory storing instructions executable by the one or more processors. The aware sign is operable to receive information (e.g., via a sensor input or a communication interface), determine, based on the received information, that the information being displayed by the visual display unit should change, and, upon a determination that the information being displayed should change, changing the information being displayed to customers, including an indication that the store is open or closed and/or an indication of the store's business operating hours. The aware sign provides a platform for a variety of features that are attractive for small business owners.

### RELATED APPLICATIONS

The present application claims priority to U.S. Provisional Patent Application Ser. No. 62/339,738, filed May 20, 2016, the disclosure of which is incorporated herein by reference in its entirety.

### FIELD OF THE DISCLOSURE

The subject matter described herein relates to signs displayed at a place of business. More particularly, it relates to a display device having the ability to dynamically change the information being displayed to customers based on sensor and other information received from sources local to or remote from the display device.

### BACKGROUND

In many organizations, communicating business hours to customers is still conducted primarily via manually updated signs hung on store entrances and/or windows. These signs let the customers know the operating hours of the business. There may also be an OPEN/CLOSED sign, lamp, light, or other indicator to communicate that status to people outside of the store or other potential customers. Both of these types of signs are either completely static (e.g., business hours painted onto a door or wall or displayed by a device that does not allow the data being displayed to be changed) or manually adjustable (e.g., an OPEN/CLOSED sign that must be flipped over, slid from side to side, or plugged in and unplugged to change from OPEN to CLOSED and vice versa).

Problems with existing solutions. Conventional, manually adjustable signs must be adjusted by a person in physical proximity to the sign, e.g., to flip the sign over, turn it on or off, etc. Completely static signs have the additional drawback that they cannot be dynamically changed in response to changing circumstances, such as reduced store operating hours due to inclement weather or emergency, or extended store operating hours due to sales events or promotions, and so on. Manually adjustable signs may be updated in response to such situations, but a person must be physically close to the sign to do so. Using inclement weather as an example, if physical access to the business location is not possible or highly discouraged (such as during a flood, hurricane, tornado, etc.), there may be nobody on the business premises to manually update the sign.

For businesses that have a web page, social media presence, or other Internet presence, there is no mechanism by changes made to a static or manually adjusted sign can be automatically reflected on the web page or social media. Synchronizing the data on the sign with the data on the Internet is also a manual process. The same issue exists for the Internet of Things (IoT), which is a development of the Internet in which everyday objects have network connectivity, allowing them to send and receive data: there is no mechanism by which changes made to a static or manually adjusted sign can be automatically made available to IoT devices that might otherwise use that information or perform some action in response to a change in status or information communicated by the sign.

There is no alternative manual or automated process that exists today that can allow for instantaneously updates and changes of the business operating hours on the published ‘sign’ controlled by a remote editor and without the presence of another human inside the store.

There is also no manual or automated process that exists today that can provide guidance to the business on what hours the nearest competitors are open so that the business owner can make intelligent decision. For example, if no competitor is open after 7 pm there may or may not be a reason for the business owner to be open until 8 pm. Alternatively, the business owner may decide to stay open after the competitor stores are closed as a way to attract additional business by serving a need that the competitors do not address.

Conventional signs are also limited in that conventional signs provide no manual or automated process and/or cognitive intelligence for persona based and personalized client retention offers displayed based on sensing the visiting customer's persona by presence. For example, in order to encourage the client to return to the business later when they visit a business while it is closed, conventional signs cannot offer and display to that client very personalized discount promotions that are specifically tailored for that client based on auto-recognition of who he/she is and their persona based on cognitive intelligence.

Conventional signs cannot use sensor data as part of a decision process to invoke special offers, prices, or deals. For example, conventional signs cannot display enticements to get clients to enter the premises, such as offering water bottles at a discount price on a very hot day, or offering umbrellas on sale if it is raining, etc.

Special needs for business that operate by appointment. For businesses that operate by appointment, such as doctors, dentists, and the like, conventional signs cannot display available time slots for prospective patients or clients. Conventional signs cannot display some type of incentive which can be offered to clients under certain circumstances, such as, for example, in the case where there has been a last minute cancellation, or for less desirable appointment times.

Special needs for small businesses. Conventional signs cannot sound a chime when it is lunch time—for example, to let the employee know they can take lunch while communicating this status to the customers by changing the operating hours dynamically and also displaying when employees will be back to work. Conventional signs are also limited in that if employee is away, e.g., at lunch, conventional signs cannot display ‘closed’ with message stating ‘will be open back at x time’ and then y minutes before approaching x time alert the employee that he/she needs to be back at work in y minutes.

Other problems not addressed by conventional signs. If an employee has not shown up to open a store, there is no easy way to find out by manager of store that the store is still closed even during regular open business hours. Conventional signs provide small business almost no insight into actual customer traffic pattern at the store. Many times Thermostats are either manual or altered to keep HVAC system running at very warm/cold temperatures and at times when the store is closed wasting energy. Conventional signs do not have the ability to sense or control a store's temperature and/or lights based on current business hours and/or current occupancy. Electric usage patterns can help lower energy wastage as well as understand usage pattern to better see the impact at locations where rates vary by time of day.

Many times employees forget to turn a conventional sign to display

OPEN, which leaves the impression that the business is closed when in fact it is not. For businesses where store times change frequently or daily or weekly it is a constant struggle to keep the times on the door accurate manually and in synchronization with various types of information about the store found online, requiring this online information to be updated manually.

Where a store does have sensors, they tend to operate in isolation and may require manual monitoring. For example if a freezer at an ice cream shop breaks down at night it can cause loss of inventory if the problem is not noticed right away.

Another issue is if the doors to the premises are accidentally left unlocked, this can cause potential loss. It is very important to sound an alert if this happens, while taking into account whether or not there is activity within the store. For example, if no client is present in the store and lights have been shut off, for example, this may indicate that the door should have been locked but was not. The time of day may be considered, as may a determination that the current time is during store operating hours or not. Conventional signs have no ability to make a decision to automatically lock doors if certain conditions are met, no ability to alert someone that the doors are unlocked when they probably should be locked, and no ability for someone to remotely lock the doors in response such a notification. The ability to remotely lock/unlock the door in particular can be huge benefit and save expensive physical trip to the location. Conventional signs do not provide this capability.

Network data can shed light on activity in the store. Such activity can be monitored or collected to get various indicators as to how many sales are being made, etc. This data can be correlated to the door opening activity to see what times clients are more likely to execute purchases vs just browsing. Conventional signs do not have this capability.

Service type business can find out how long the wait times are for clients and if more help may be needed or should be called. Sensors/Cameras can detect for example how many waiting chairs are occupied and report this to the manager using messaging/alert services. Conventional signs do not have this capability.

Conventional signs provide no way for business hours to be set in advance for the whole month or a year and to be updated periodically or at other prescribed schedule at the store and on other web site/services in parallel automatically.

Conventional signs do not meet the needs described above.

### SUMMARY

The present disclosure provides a new, unique, and novel solution for the problems described above. An “aware sign” having processing, networking, and sensing capabilities coupled with an ability to display status or information to customers and potential customers is an ideal platform for providing solutions to these problems. Those skilled in the art will appreciate the scope of the present disclosure and realize additional aspects thereof after reading the following detailed description in association with the accompanying drawings.

According to one aspect, a method of operation of an aware sign having a visual display unit for displaying information to customers at a store comprises receiving information from a sensor input for receiving information from a sensor or from a communication interface for communicating with other devices via a network, determining, based on the received information, that information being displayed on the visual display unit should change, and upon a determination that the information being displayed should change, changing the information being displayed to customers. The information being displayed to customers includes an indication that the store is open or closed and/or an indication of the store's business operating hours.

In one embodiment, the information received comprises at least one of: information about weather conditions, information indicating current occupancy of the store premises, information indicating current activity within or outside the store premises, information about the status of points of entry into the store premises, intrusion detection information, information about the status of equipment within or associated with the store premises, information from temperature sensors, fire detectors, smoke detectors, gas detectors, motion detectors, and intrusion detectors within or associated with the store premises, and information related to the operating status of other stores proximate to the store premises.

In one embodiment, upon the determination that information being displayed should change, the method includes sending an electronic notification to at least one person.

In one embodiment, upon the determination that information being displayed should change, the method includes updating a website or social media outlet.

In one embodiment, the information being displayed to customers includes notification of an available appointment slot or notification of a discount associated with an available appointment slot.

In one embodiment, the information being displayed to customers includes a reward, sale, coupon, promotion, discount, or incentive.

In one embodiment, the method includes identifying a customer who is proximate to the aware sign and wherein the information being displayed to customers includes a personalized incentive for the identified customer.

In one embodiment, identifying a customer comprises identifying a customer based on at least one of: a cell phone signal; an International Mobile station Equipment Identity (IMEI); an International Mobile Subscriber Identity (IMSI); a Radio Frequency Identification (RFID) signal; a wireless communication signal; facial recognition; voice recognition; a fingerprint; a biometric identifier; and information manually entered by the customer.

In one embodiment, the method further comprises, in response to determining that the store should be open but is not and that the store is currently unoccupied, sending an electronic notification to at least one person.

In one embodiment, determining that the store should be open but is not comprises determining that the current time is within store hours of operation and determining that the doors to the store are locked or that the store lights are off.

In one embodiment, the method further comprises, in response to determining that the store should be closed, that an access point into the store is open or unlocked, and that the store is currently unoccupied, sending an electronic notification to at least one person.

In one embodiment, determining that the store is unoccupied comprises determining that a motion, proximity, or image sensor indicates no activity within the store premises.

In one embodiment, the method further comprises logging sensor information and analyzing the sensor information to determine at least one of customer occupancy patterns, sales activity patterns, and energy consumption patterns.

In one embodiment, the method further comprises determining client wait times, and upon a determination that client wait times exceed a first threshold, providing a notification that additional help is needed.

According to another aspect, an aware sign comprises a visual display unit for displaying information to customers at a store, a processor, and a memory storing instructions executable by the one or more processors. The aware sign is operable to receive information, to determine, based on the received information, that the information being displayed should change, and, upon a determination that the information being displayed should change, change the information being displayed to customers. The information being displayed includes an indication that the store is open or closed and/or an indication of the store's business operating hours.

In one embodiment, the aware sign further comprises a communication interface for communicating with other devices via a network.

In one embodiment, the aware sign further comprises a sensor input for receiving information from a sensor.

In one embodiment, the sensor input receives information from at least one of: a temperature sensor; a fire detector; a smoke detector; a motion detector; an intrusion detector; an activity detector; a periphery detector; a door or window sensor; a precipitation detector; a wind speed detector; an equipment sensor; a power meter; a light sensor; a sound sensor; and a pressure sensor.

In one embodiment, the aware sign further comprises a security module for providing security services for the store.

In one embodiment, the security services include at least one of encryption and decryption of communications to, from, or within the aware sign, authentication, authorization, and access control, threat detection and abatement, and intrusion detection and notification.

In one embodiment, the security services include, in response to detecting activity within or proximate to the store premises outside of business operating hours, sending an electronic notification of such to at least one person.

In one embodiment, the aware sign further comprises an Application Programming Interface (API) and Input/Output (IO) interface for accepting input from or communicating with external devices and for allowing access to the hardware or software within the aware sign.

In one embodiment, the aware sign further comprises an expansion bus for accepting additional hardware modules that communicate with at least some of the other components within the aware sign.

In one embodiment, the visual display unit comprises a plurality of display sections.

In one embodiment, at least one of the plurality of display sections comprises a different type of display from the others of the plurality of display sections.

In one embodiment, the access to the hardware or software within the aware sign is local access or remote access.

Those skilled in the art will appreciate the scope of the present disclosure and realize additional aspects thereof after reading the following detailed description in association with the accompanying drawings.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram illustrating an exemplary aware sign according to an embodiment of the present disclosure.

FIG. 2 is a block diagram of the aware sign from a software perspective according to an embodiment of the present disclosure.

FIGS. 3A and 3B are flow charts illustrating a process that may be performed by a conventional sign versus by an exemplary aware sign according to an embodiment of the present disclosure, respectively.

FIGS. 4A and 4B are flow charts illustrating another process that may be performed by a conventional sign versus by an exemplary aware sign according to an embodiment of the present disclosure, respectively.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

The subject matter of the present disclosure provides a new, unique, and novel solution for the problems described above. The subject matter of the present disclosure includes a cognitive digital device, referred to herein as an “aware sign”, which can be owned, managed and hung by a window, on a wall, from a ceiling, etc., by a business or store owner/manager in a manner similar to how a conventional sign would be used. However, the aware sign also allows for remote digital manipulation of the business operating hours for display purposes, and, as will be described below, may provide many additional features.

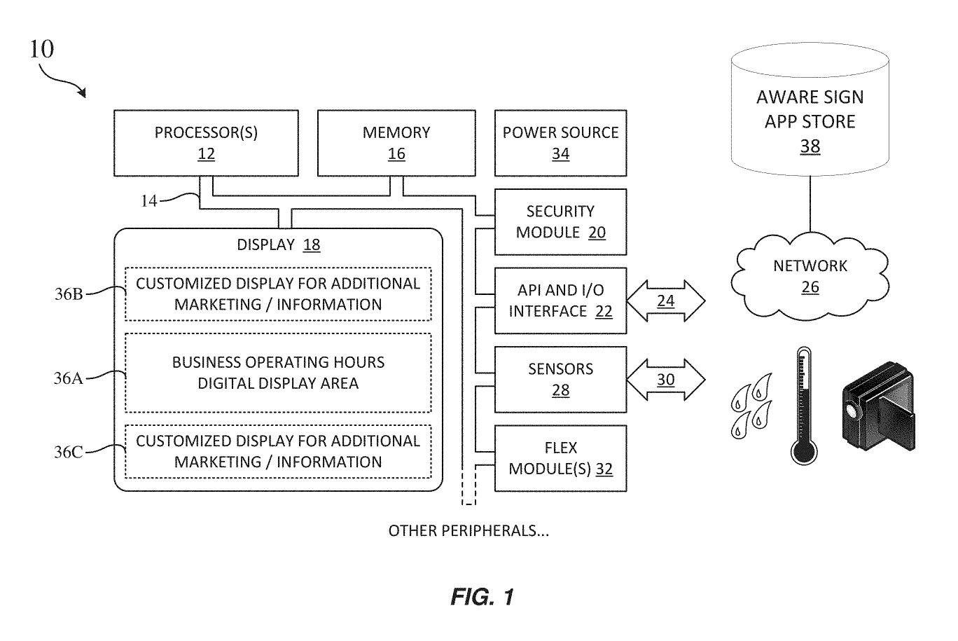

FIG. 1 is a block diagram illustrating an exemplary aware sign according to an embodiment of the present disclosure. In the embodiment illustrated in FIG. 1, an aware sign 10 includes one or more processors 12 that communicate with other devices via a communications bus 14, such as a data/address bus. In the embodiment illustrated in FIG. 1, other devices that are attached to the bus include, but are not limited to, the following:

A memory 16 for storing computer executable instructions, such as programs, for execution by the one or more processors 12.

A display unit 18, for displaying information to shoppers or other persons within the store or otherwise proximate to the aware sign 10. The display unit 18 can be any type of display device, from a simple light-up display to a full color video display terminal, such as an LCD, LED, or CRT monitor.

A security module 20 for providing security services, including, but not limited to, encryption/decryption, authentication, authorization, access control, threat detection and abatement, and notification. In one embodiment, the security module 20 may serve functions of providing both physical security as well as cyber security. Regarding physical security, in one embodiment this security module 20 can act as an alarm that gets armed when store hours end and can send intruder alert to police in case of an unlawful entry, for example.

Regarding cyber security, in one embodiment the security module 20 protects the device and the associated apps in AwareSign App store from all kind of cyber threats, for example

An Application Programming Interface (API) and Input/Output (I/O) interface 22, which accepts input from and/or communicates with external devices via communications links 24, which may be via wired and/or wireless connections. The API and IO interface 22 allows access to the hardware and/or software within the aware sign 10, and may be the means by which the aware sign 10 is configured as well as a means by which the aware sign 10 communicates with a local network, the Internet, the Internet of Things (IoT), or other networks 26 and/or entities. In one embodiment, the API and IO interface 22 allows for exchange of information objects with remote users and remote devices. In one embodiment, the API and IO interface 22 may include the modules to interface via Open APIs with remote users, software, and remote devices that are part of the IoT.

One or more sensors 28, which provide sensor inputs to the aware sign 10 and which may also communicate with external sensors or other devices via communications links 30. Examples of sensors include, but are not limited to: temperature sensors; cameras, video or image sensors; sound sensors; motion sensors or motion detection sensors; weather, wind, precipitation, or outside temperature sensors; heat sensors, smoke sensors, carbon monoxide or other gas sensors; intrusion detection sensors, and human/animal presence detection sensors; and so on.

Other types of modules 32, which may be referred to herein as “flex modules” and which can be any type of peripheral. Flex modules 32 may be used for augmenting, enhancing, or extending the functionality of the aware sign 10. Examples of flex modules 32 include, but are not limited to, additional processors or memory, additional sensors, real-time clocks, wireless transceivers, communications or I/O port modules, custom application hardware and/or software, etc. In one embodiment, the architecture of the aware sign 10 is flexible and component based—which simply means that it has the ability to ‘plug and play’ additional functional modules even after it has been deployed. These modules can be added to the device post sale of the original device as new modules with additional features are introduced. The extensible nature of the aware sign 10 allows it to be (re)configured as needs change. These modules and sensors may be used by corresponding applications running on the aware sign 10.

In one embodiment, the architecture of the aware sign 10 may be closed or proprietary, in which case the set of modules contained within any particular aware sign 10 is not configurable by the user. In another embodiment, the architecture of the aware sign 10 may be open, e.g., allowing the user to configure the aware sign 10 with additional modules 32 or other peripherals (e.g., microphones, speakers, mass storage devices, additional memory, etc.) at will.

In the embodiment illustrated in FIG. 1, system 10 includes a power source 34 or other form of power module for providing power to the components within or attached to the aware sign 10. The power source 34 may be replaceable, rechargeable, or both. The power source 34 may provide AC power, DC power, or both. The power source 34 may include an Uninterruptable Power Supply (UPS).

As will be described in more detail below, the information being presented by display 18 may dynamically change programmatically and/or in response to detected conditions, trigger events, and/or instructions generated internally or received from external sources. In the embodiment illustrated in FIG. 1, the display 18 is partitioned into different sections 36A, 36B, and 36C, which may be collectively referred to as “sections 36” or individually as “a section 36”.

In the embodiment illustrated in FIG. 1, the display 18 includes a first section 36A for displaying the business operating hours and two customized display sections 36B and 36C for displaying additional information. The number, size, positions(s), and contents of the display sections illustrated in FIG. 1 are intended to be illustrative and not limiting. In one embodiment, the business operating hours information may be digitally published and displayed via remote access from anywhere in the world by the owner/manager of the device who has secure credentials to do so.

In one embodiment, the aware sign 10 may download or otherwise receive applications from a store or other repository of such applications. In the embodiment illustrated in FIG. 1, the AwareSign App Store 38 is such a repository. In one embodiment, the aware sign 10 may download applications from the AwareSign App Store 38 via the network 26, via a storage device such as a flash drive that is plugged into the aware sign 10, or via other means.

In one embodiment, the aware sign 10 is electronically connected to the ‘Internet of Things’ (IoT), and has embedded sensors (e.g.: for cognitive facial and persona recognition, motion sensors, human/animal-presence, temperature sensing, etc.) and a highly scalable software architecture that exploits the open API economy to connect to and provide an extensible number of automation services. In one embodiment, in addition to the business hours operations display area, the aware sign 10 may use one or more of the additional digital display areas 36B and 36C to interact electronically with the IoT (e.g., via an appropriate AwareSign App Store 38 app) and can display useful information to the customers such as personalized marketing promotions. In one embodiment, display areas 36B or 36C may be used by businesses selling to that store to promote their products directly to the store's customers.

In one embodiment, the aware sign 10 comes with a mounting and assembly module that allows it to be placed at a very convenient location in the store/business that will be using the aware sign 10.

In one embodiment, the aware sign 10 has an additional display area that can display information in addition to the business operating hours.

The aware sign 10 may also provide new and highly automated and value-added solutions to the problems listed above. All known existing solutions to these problems are manual and cumbersome or piecemeal. The aware sign 10 provides a single entity that can address all of the problems listed above.

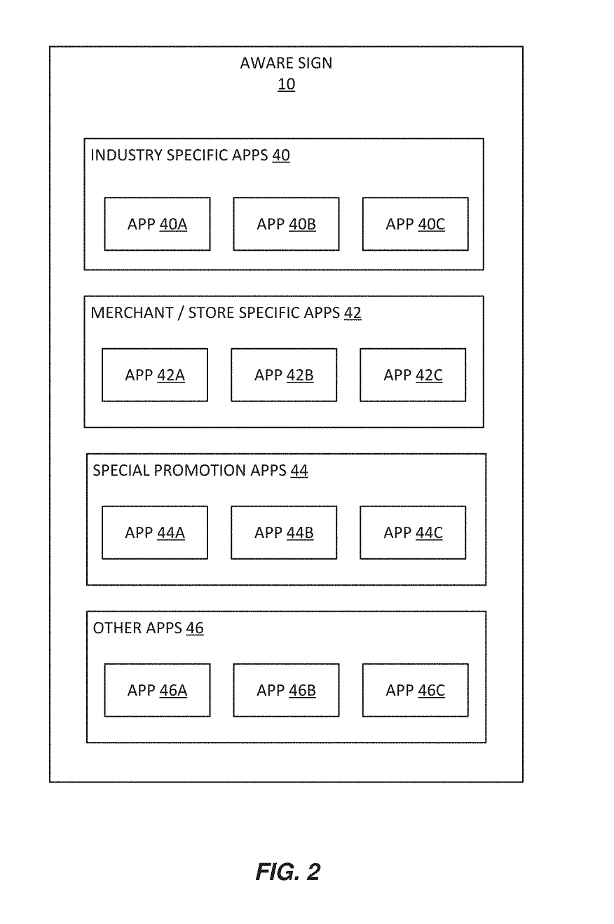

FIG. 2 is a block diagram of the aware sign 10 from a software perspective. The aware sign 10 may host different categories of applications (also referred to as “apps”). In the embodiment illustrated in FIG. 2, for example, the aware sign 10 may host or support industry-specific applications 40, merchant-specific or store-specific applications 42, special promotional applications 44, as well as other applications 46. In the embodiment illustrated in FIG. 2, there are three industry-specific applications, identified as “app 40A”, “app 40B”, and “app 40C”, three merchant/store specific applications, identified as “app 42A”, “app 42B”, and “app 42C”, three special promotional applications, identified as “app 44A”, “app 44B”, and “app 44C”, and three other applications, identified as “app 46A”, “app 46B”, and “app 46C”, but the number of applications of each type, and the number of types, are shown for illustration purposes only. Any number of applications or types of applications is within the scope of the present disclosure.

Examples of industry-specific applications 40 include, but are not limited to: Point of Sale (POS) terminal or cash-register applications; coupons and incentives applications; stock/inventory tracking and management applications; and so on. Grocery stores, for example, may run applications that monitor the temperature of storage freezers, or that provide alarms if stock of any particular item is below a target threshold (in which case more stock may be ordered) or above a target threshold (in which case the item may be put on sale to clear inventory).

Examples of merchant- or store-specific applications 42 include, but are not limited to loyalty club applications; bonus applications; and customer identification/retention applications.

Examples of special promotional applications 44 include, but are not limited to: applications that offer or redeem coupons, offers, and incentives, which may be provided by the store, the merchant organization, a distributor, and/or a manufacturer.

Examples of other applications 46 include, but are not limited to: applications for detecting the presence of customers within or proximate to the store premises; applications for detecting environmental conditions; security applications; networking/communication applications; and so on.

Detecting the presence of customers within or proximate to the store premises may include identifying those customers. Customers may be identified, for example, based on: a cell phone signal or information provided by a cell phone, such as an International Mobile station Equipment Identity (IMEI) or International Mobile Subscriber Identity (IMSI); a Radio Frequency Identification (RFID) signal; a wireless communication signal; facial recognition; voice recognition; a fingerprint; a biometric identifier; and information manually entered by the customer.

In one embodiment, an associated AwareSign App Store 38 feature also provides the owner of the aware sign 10 with new, highly automated, and value-added solutions to the problems listed above. In one embodiment, some applications may use one or more sensors 28 present in the aware sign 10 to provide value-add digital services to the business owner/manager of the aware sign 10. These sensors can interact with cognitive apps, i.e., applications that perform facial or identity recognition, available from the AwareSign App Store 38 to provide useful and value-added information to the store owner and the customer.

In one embodiment, the AwareSign App Store 38 is a catalogue of software applications which are designed to run on any mobile device (such as a tablet, smart phone, smart watch, etc.) and to be accessible via the cloud network 26, and which can service requests across the Internet of Things. A set of software applications may be selected to address some or all of the problems described above, and will allow the aware sign 10 to provide automated solutions to problems that have neither a manual or automated solution today, and/or provide automated solutions to problems with have only a manual or semi-automated solution today.

As will now be discussed, one advantage of the aware sign 10 over conventional signs is that the aware sign 10 solves problems for which either there is no existing manual or automated solution or for which where is no highly automated solution.

Solutions Provided.

In contrast to conventional, manually adjustable signs, which must be adjusted by a person in physical proximity to the sign, the aware sign 10 may remotely manipulated to change the status from OPEN to CLOSED (or the reverse), to turn the sign on or off, etc. The aware sign 10 may be programmed to automatically change its status according to operating hours defined for the store and maintained with the aware sign 10 itself, and may also be locally or remotely controlled instead of using programmed times or as an override to the programmed times. Remote control of the aware sign 10 may be via any communications means, including over the Internet, via telephone/modem, via any dedicated hardware connection, and via wireless connection, including a cellular network, a wireless LAN, a Wi-Fi connection, a Bluetooth connection, an infrared connection, and so on. In one embodiment, for example, a person who has authority to make changes to the aware sign 10 (hereinafter referred to as “the owner”), may use an application on his or her mobile device to check the status of the sign, make changes to the sign, initiate features or programs hosted by the sign, and so on, without having to be in physical proximity to the sign itself.

In contrast to completely static signs that cannot be dynamically changed in response to changing circumstances, such as reduced store operating hours due to inclement weather or emergency, or extended store operating hours due to sales events or promotions, the aware sign 10 may be programmed to dynamically change its behavior, what it displays, etc., in response to such stimuli and without requiring a person to be physically close to the aware sign 10. Using inclement weather as an example, if physical access to the business location is not possible or highly discouraged (such as during a flood, hurricane, tornado, etc.), the sign may be remotely updated from the safety of a remote location.

In one embodiment, the aware sign 10 may be configured to send email, text message, or other electronic notifications to employees, management, or even preferred or non-preferred clients in the event of a change of business operating hours. For example, if a store must be closed due to severe weather, the store manager may remotely change the business hours displayed on the sign. In one embodiment, the aware sign 10 may determine whether any clients had scheduled appointments during the time that was formerly during operating hours but now is not, and automatically send notification to those clients that their appointments are cancelled and must be rescheduled. Likewise, the aware sign 10 may determine that certain employees were scheduled to arrive at work (for a late shift, for example) but are no longer needed due to the store closure. In this scenario, the aware sign 10 may notify those employees that they should not come in to work because the store is or will be closed during that time.

Unlike conventional signs, the aware sign 10 provides a mechanism by which changes made to the sign can be automatically reflected on the web page or social media page of the establishment. Changes may also automatically be made available to local or remote IoT devices. The aware sign 10 may trigger updates to such devices automatically, such as in response to detection of specific conditions. The aware sign 10 provides the capability to instantly synchronize changes to business operating hours or other information displayed on the aware sign 10 with web content or social media.

Unlike conventional signs, the aware sign 10 provides a mechanism by which the business owner can make an intelligent decision about business hours by taking into account the business hours of nearby competitors. For example, standard web-crawling or “screen scraping” programs hosted by the aware sign 10 may harvest business hours information from competitor websites, which the aware sign 10 may use make decisions about, or provide suggestions about, business hours.

Unlike conventional signs, the aware sign 10 provides a platform for manual or automated process and/or cognitive intelligence for persona based and personalized client retention offers displayed based on sensing the visiting customer's persona by presence. For example, in order to encourage the client to return to the business later when they visit a business while it is closed, the aware sign may detect the presence of a client at or near the premises and offer to that client some promotion or incentive to return to the store. In one embodiment, the aware sign 10 may be able to identify the client and display to that client very personalized discount promotions that are specifically tailored for that client based on auto-recognition of who he/she is and their persona based on cognitive intelligence.

Unlike conventional signs, the aware sign 10 can use sensor data as part of a decision process to invoke special offers, prices, or deals, such as offering water bottles at a discount price on a very hot day, or offering umbrellas on sale if it is raining, etc.

For businesses that operate by appointment, such as doctors, dentists, and the like, the aware sign 10 can display available time slots for prospective patients or clients. The aware sign 10 may display some type of incentive which can be offered to clients under certain circumstances, such as, for example, in the case where there has been a last minute cancellation, or for less desirable appointment times. For example, the aware sign 10 may display a notice such as “Come in at 4 pm for a dental cleaning and get 10% off!” In this manner, the aware sign 10 may be instrumental in creating new business for the proprietor.

Unlike conventional signs, the aware sign 10 can provide services that are especially attractive for small business. For example, the aware sign 10 may be programmed to sound a chime when it is lunch time—for example, to let the employee know they can take lunch while communicating this status to the customers by changing the operating hours dynamically and also displaying when employees will be back to work. In one embodiment, the aware sign 10 may display a ‘closed’ with message stating ‘will be open back at x time’ and then, y minutes before approaching x time, alert the employee that he/she needs to be back at work in y minutes.

Unlike conventional signs, the aware sign 10 can address problems that historically have nothing whatsoever to do with a conventional sign. For example, without the aware sign 10, if an employee has not shown up to open a store, there is no easy way for the manager of the store to find out that the store is still closed even during regular open business hours. In one embodiment, the aware sign 10 may be configured with motion sensors, door lock sensors, and the like, and can detect, for example, that the store should be open but the doors are still locked and/or there is nobody within the store, and respond to that detection by sending a text message to the manager to notify him or her that the store is closed when it should be open.

Unlike conventional signs, which provide small business almost no insight into actual customer traffic pattern at the store, the aware sign 10 may log such traffic patterns based on sensor inputs. In one embodiment, the aware sign 10 may provide historical or statistical data to the business owner, who may use that information to adjust business hours or staffing numbers as appropriate.

Because the aware sign 10 may not only sense conditions but also control them, in one embodiment the aware sign 10 may monitor a store's temperature, lights, heating/ventilation/air conditioning (HVAC) system, and son on, to detect when a store is wasting energy, especially when the store is closed. In one embodiment, the aware sign 10 may actively control these systems to reduce needless energy use. In one embodiment, the aware sign 10 may track electricity usage patterns to help lower energy wastage as well as understand usage pattern to better see the impact, especially at locations where power rates vary by time of day. In those locations, the aware sign 10 may intelligently turn off the air conditioning during peak rate times, for example. The aware sign 10 is also in a position to detect equipment failures and report them to the necessary persons. For example, the aware sign 10 may monitor the temperature of storage or display units and send an alert if a freezer is getting too warm.

Many times employees forget to turn a conventional sign to display OPEN, which leaves the impression that the business is closed when in fact it is not. For businesses where store times change frequently or daily or weekly it is a constant struggle to keep the times on the door accurate manually and in synchronization with various types of information about the store found online, requiring this online information to be updated manually. The aware sign 10 can eliminate this problem by handling this task programmatically, not only for the store but across all ecommerce sites, web sites, social media sites, and so on.

The aware sign 10 can address another serious issue, namely that the doors to the premises may be accidentally left unlocked after hours, which gives an opportunity for theft or other potential loss. In one embodiment, the aware sign 10 may be configured to sound an alert if this happens, while taking into account whether or not there is activity within the store. For example, if no client is present in the store and lights have been shut off, for example, this may indicate that the door should have been locked but was not. The time of day may be considered, as may a determination that the current time is during store operating hours or not. In one embodiment, the aware sign 10 may make a decision to automatically lock doors if certain conditions are met, to alert someone that the doors are unlocked when they probably should be locked, and/or to provide a manager or other person the ability to remotely lock the doors in response such a notification. The ability to remotely lock/unlock the door in particular can be huge benefit and save expensive physical trip to the location. Network data can shed light on activity in the store. Such activity can be monitored or collected to get various indicators as to how many sales are being made, etc. This data can be correlated to the door opening activity to see what times clients are more likely to execute purchases vs just browsing. Conventional signs do not have this capability.

The aware sign 10 provides a convenient platform by which service type business can find out how long the wait times are for clients and if more help may be needed or should be called. Client wait times may be determined or estimated in a number of ways. For example, sensors or cameras can detect for example how many waiting chairs are occupied; wait times may be determined based on the delay between the time that a customer is given a number and the time that the number is called to indicate that service is being provided to that customer; sensors or cameras can detect how many register lines are open and how many customers are in each line; clients may report to the business that they have been waiting too long, e.g., via a mobile app or via a complaint to an employee who then enters this information into the system; and so on. In one embodiment, once excessive wait times have been detected or reported, the aware sign may report this to the manager, e.g., using messaging/alert services. Likewise, the aware sign may broadcast a prerecorded message (e.g., “help needed at the register”) over store speakers or to store employees. In one embodiment, wait time information may be logged and later analyzed to determine when the store is busy or not busy so that an appropriate number of employees are present to handle the need, e.g., to help schedule the right number of workers at the right time for the predicted need.

Unlike conventional signs, the aware sign 10 provides a mechanism for business hours to be set in advance for the whole month or a year and to be updated periodically or at other prescribed schedule at the store and on other web site/services in parallel automatically.

Comparison Cases.

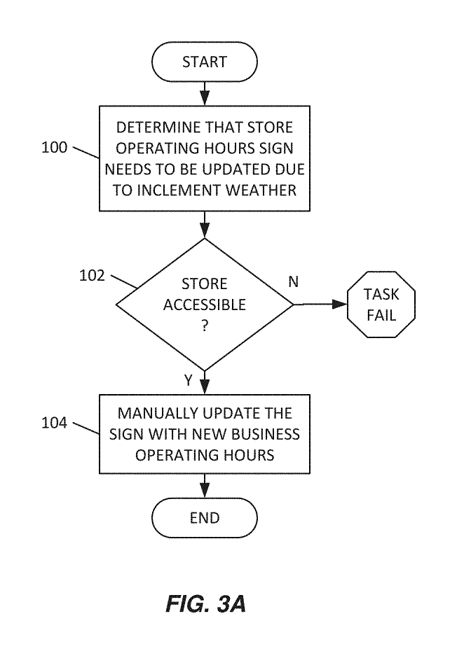

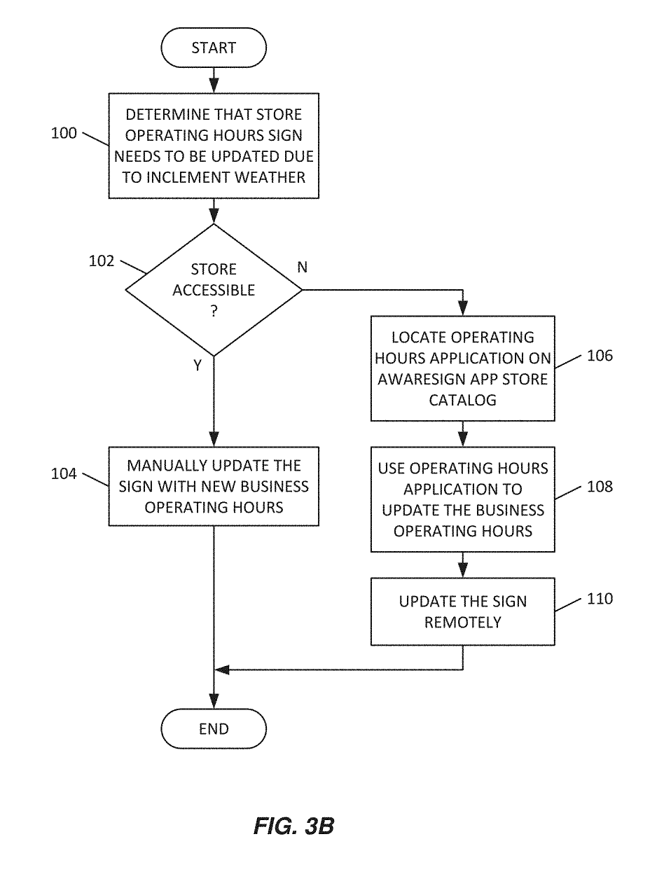

FIGS. 3A and 3B are flow charts illustrating a process that may be performed by a conventional sign versus by an exemplary aware sign according to an embodiment of the present disclosure, respectively.

FIG. 3A is a flow chart illustrating a process performed at a store with a conventional sign. In the embodiment illustrated in FIG. 3A, it is determined that the store operating hours sign should be updated due to inclement weather (step 100). If the store is accessible (step 102), the conventional sign is manually updated with new business operating hours (step 104); if the store is not accessible (step 102), this task fails—i.e., the store sign incorrectly lists the store as being open when it is not.

FIG. 3B is a flow chart illustrating the same task as it may be performed at a store with an aware sign 10. Here also, it is determined that the store operating hours sign should be updated due to inclement weather (step 100). If the store is accessible (step 102), the conventional sign is manually updated with new business operating hours (step 104). If the store is not accessible (step 102), however, the owner, manager, or other authorized employee may locate the operating hours application on the AwareSign App Store catalog (step 106), use the operating hours application to update the business operating hours (step 108), and update the aware sign 10 remotely (step 110). These steps may be performed remotely. Once the aware sign 10 is updated, it will change what it displays to the customers. For example, it may update the operating hours for the day (e.g., “Monday: 9:00 AM-5:00 PM” may change to “Monday: 9:00 AM-2:00 PM”), and, if the store is now closed due to the operating hours change, the aware sign 10 may change the store status from

“OPEN” to “CLOSED”. In one embodiment, the owner may provide additional information to be displayed on the aware sign 10, such as “Store closed today due to weather, but will be open tomorrow until 7:00 PM”.

In one embodiment, the AwareSign App Store is a suite of applications which the use can download and install into the aware sign 10 to customize or extend functionality of the sign itself. Access to these applications on the aware sign 10 may directly, e.g., via a physical interface on the aware sign 10 itself, or remotely, e.g., via a web browser portal into the aware sign 10 or via stand-alone application for that purpose that does not require a web browser. In an alternative embodiment, the AwareSign App Store may be a Software As A

Service (SAAS) application, which the user logs into to perform configuration, maintenance, or other tasks, and the SAAS platform handles the communication and interaction with the aware sign 10, i.e., the user does not have direct access to the aware sign 10, but only access to the SAAS that has direct access to the aware sign 10.

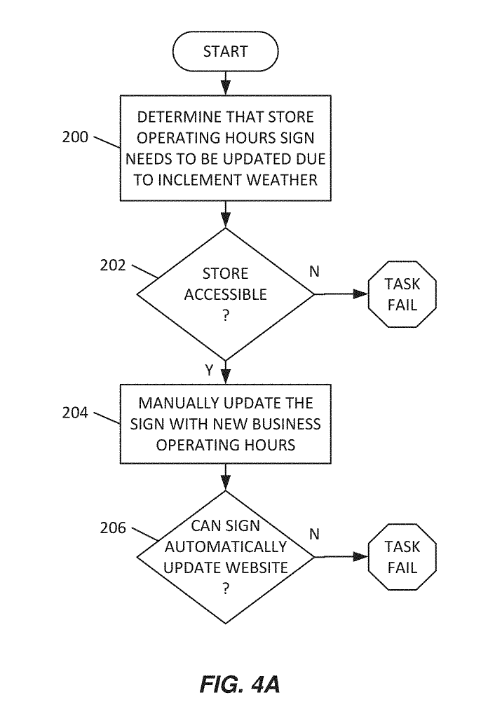

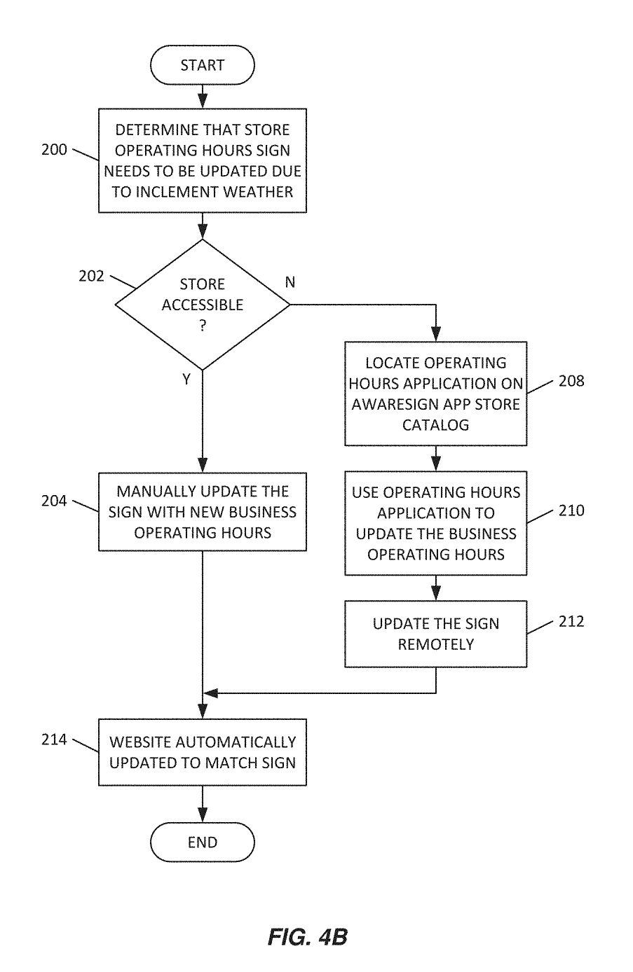

FIGS. 4A and 4B are flow charts illustrating another process that may be performed by a conventional sign versus by an exemplary aware sign according to an embodiment of the present disclosure, respectively.

FIG. 4A is a flow chart illustrating a process performed at a store with a conventional sign. In the embodiment illustrated in FIG. 4A, it is determined that the store operating hours sign should be updated due to inclement weather (step 200). If the store is accessible (step 202), the conventional sign is manually updated with new business operating hours (step 204); if the store is not accessible (step 102), this task fails—i.e., the store sign incorrectly lists the store as being open when it is not. Even if the store is accessible, and the conventional sign can be manually updated to show the new business hours, conventional signs cannot automatically update the store's website (step 206), so that task fails—i.e., the store's website continues to show incorrect information.

FIG. 4B is a flow chart illustrating the same task as it may be performed at a store with an aware sign 10. Here also, it is determined that the store operating hours sign should be updated due to inclement weather (step 200). If the store is accessible (step 202), the conventional sign is manually updated with new business hours (step 204). If the store is not accessible (step 202), however, the owner, manager, or other authorized employee may locate the operating hours application on the AwareSign App Store catalog (step 208), use the operating hours application to update the business operating hours (step 210), and update the aware sign 10 remotely (step 212). These steps may be performed remotely. Once the aware sign 10 is updated, it will change what it displays to the customers. Whether or not the store is accessible, the process eventually gets to step 214, where the aware sign 10 automatically updates the store website to show the updated business hours, other messages, and so on.

The aware sign provides a platform that enables services that are not traditionally provided by merchants. For example, in one embodiment, an aware sign visible or accessible to someone outside of the merchant premises may have a camera or other scanner to which a potential customer can display a picture, bar code, Universal Product Code (UPC), or other identifier, of an item that they desire to purchase. Upon identification of the item presented, the aware sign can display to the potential customer information to notify the potential customer whether the item is or is not currently in stock at that store.

If the item is in stock, the aware sign may display useful information such as: the item's price; how many of the items are in stock; where the item is located within the store; discounts, coupons, sales, or other incentives available; etc.

If the item is NOT in stock, the aware sign may display an estimated date when the item will be available. The aware sign may display a list of nearby stores where the item IS in stock. The aware sign may display information, such as a bar code, which, when scanned by the potential customer's phone, will open a merchant's web page from which the customer may buy the desired item.

In one embodiment, a mobile application may be provided by which a user may select or otherwise identify a desired item, and in response, the mobile application can identify, for example, (a) stores that are nearby, (b) that are currently open, (c) that carry that item, and (d) that have that item currently in stock. Other information that may be provided includes, but is not limited to, price of the item, number of items left in stock, location within the identified store, etc. In one embodiment, the mobile application may interact with a proximate aware sign, which provides that information about the store closest to the user of the mobile application. Alternatively, the mobile application may directly or indirectly (e.g., via a network server) communicate with multiple aware signs, which provide that desired information in response to a query for such information.

Other examples of information that may be received and used by the aware sign 10 includes: information about weather conditions, information indicating current occupancy of the store premises, information indicating current activity within or outside the store premises, information about the status of points of entry into the store premises, intrusion detection information, information about the status of equipment within or associated with the store premises, information from temperature sensors, fire detectors, smoke detectors, gas detectors, motion detectors, and intrusion detectors within or associated with the store premises, and information related to the operating status of other stores proximate to the store premises.

In one embodiment, the operating status of other stores proximate to the store premises may be derived, for example, from observed or detected traffic to or from the other stores (e.g., based on motion detection or visual feed from a camera that is directed towards the other store's entrance). Alternatively, this operating status may be determined based on traffic into a common area, such as a mall entrance (e.g., the number of people entering a mall minus the number of people entering the store premises gives an indication of the number of people entering other store premises). Alternatively, this operating status may be based on information shared among stores.

Thus, the aware sign 10 is a convenient platform that is uniquely positioned to provide solutions for a wide variety of problems faced by large and small businesses. Because every physical store should have a sign that indicates business hours and open/closed status, the aware sign 10 could have nearly ubiquitous deployment. The ability of aware sign 10 to accept sensor inputs, provide control outputs, and provide communications capability, make it especially suited for the tasks described above.

Those skilled in the art will recognize improvements and modifications to the embodiments of the present disclosure. All such improvements and modifications are considered within the scope of the concepts disclosed herein and the claims that follow.

What is claimed is:

1. A method of operation of an aware sign having a visual display unit for displaying information to customers at a store, the method comprising:
receiving information from a sensor input for receiving information from a sensor or from a communication interface for communicating with other devices via a network;
determining, based on the received information, that information being displayed on the visual display unit should change; and
upon a determination that the information being displayed should change, changing the information being displayed to customers, the information comprising at least one of:
an indication that the store is open or closed; and
an indication of the store's business operating hours.

2. The method of claim 1 wherein the information received comprises at least one of:
information about weather conditions;
information indicating current occupancy of the store premises;
information indicating current activity within or outside the store premises;
information about the status of points of entry into the store premises;
intrusion detection information;
information about the status of equipment within or associated with the store premises;
information from temperature sensors, fire detectors, smoke detectors, gas detectors, motion detectors, and intrusion detectors within or associated with the store premises; and
information related to the operating status of other stores proximate to the store premises.

3. The method of claim 1 wherein, upon the determination that information being displayed should change, sending an electronic notification to at least one person.

4. The method of claim 1 wherein, upon the determination that information being displayed should change, updating a website or social media outlet.

5. The method of claim 1 wherein the information being displayed to customers includes notification of an available appointment slot or notification of a discount associated with an available appointment slot.

6. The method of claim 1 wherein the information being displayed to customers includes a reward, sale, coupon, promotion, discount, or incentive.

7. The method of claim 6 further comprising identifying a customer who is proximate to the aware sign and wherein the information being displayed to customers includes a personalized incentive for the identified customer.

8. The method of claim 7 wherein identifying a customer comprises identifying a customer based on at least one of: a cell phone signal; an International Mobile station Equipment Identity (IMEI); an International Mobile Subscriber Identity (IMSI); a Radio Frequency Identification (RFID) signal; a wireless communication signal; facial recognition; voice recognition; a fingerprint; a biometric identifier; and information manually entered by the customer.

9. The method of claim 1, further comprising:
in response to determining that the store should be open but is not and that the store is currently unoccupied, sending an electronic notification to at least one person.

10. The method of claim 9 wherein determining that the store should be open but is not comprises determining that the current time is within store hours of operation and determining that the doors to the store are locked or that the store lights are off.

11. The method of claim 1, further comprising:
in response to determining that the store should be closed, that an access point into the store is open or unlocked, and that the store is currently unoccupied, sending an electronic notification to at least one person.

12. The method of claim 11 wherein determining that the store is unoccupied comprises determining that a motion, proximity, or image sensor indicates no activity within the store premises.

13. The method of claim 1, further comprising logging sensor information and analyzing the sensor information to determine at least one of: customer occupancy patterns; sales activity patterns; and energy consumption patterns.

14. The method of claim 1, further comprising determining client wait times, and upon a determination that client wait times exceed a first threshold, providing a notification that additional help is needed.

15. An aware sign, comprising:
a visual display unit for displaying information to customers at a store;
a processor; and
a memory storing instructions executable by the one or more processors, whereby the aware sign is operable to:
receive information;
determine, based on the received information, that information being displayed by the visual display unit should change; and
upon a determination that the information being displayed by the visual display unit should change, change the information being displayed to customers,
wherein the information being displayed comprises at least one of:
an indication that the store is open or closed; and
an indication of the store's business operating hours.

16. The aware sign of claim 15, further comprising a communication interface for communicating with other devices via a network.

17. The aware sign of claim 15, further comprising a sensor input for receiving information from a sensor.

18. The aware sign of claim 17 wherein the sensor input receives information from at least one of: a temperature sensor; a fire detector; a smoke detector; a motion detector; an intrusion detector; an activity detector; a periphery detector; a door or window sensor; a precipitation detector; a wind speed detector; an equipment sensor; a power meter; a light sensor; a sound sensor; and a pressure sensor.

19. The aware sign of claim 15, further comprising a security module for providing security services for the store.

20. The aware sign of claim 19 wherein the security services include at least one of:
encryption and decryption of communications to, from, or within the aware sign;
authentication, authorization, and access control;
threat detection and abatement; and
intrusion detection and notification.

21. The aware sign of claim 19 wherein the security services include, in response to detecting activity within or proximate to the store premises outside of business operating hours, sending an electronic notification of such to at least one person.

22. The aware sign of claim 15 further comprising an Application Programming Interface (API) and Input/Output (IO) interface for accepting input from or communicating with external devices and for allowing local or remote access to the hardware or software within the aware sign.

23. The aware sign of claim 15 comprising an expansion bus for accepting additional hardware modules that communicate with at least some of the other components within the aware sign.

24. The aware sign of claim 15 wherein the visual display unit comprises a plurality of display sections.

25. The aware sign of claim 24 wherein at least one of the plurality of display sections comprises a different type of display from the others of the plurality of display sections.
